(19) United States
(12) Patent Application Publication
(10) Pub. No.: US 2009/0249353 A1
(43) Pub. Date: Oct. 1, 2009

(54) COMPUTER OPERATIONS CONTROL BASED ON PROBABLISTIC THRESHOLD DETERMINATIONS

(75) Inventor: David Kevin Siegwart, Eastleigh (GB)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/367,601

(22) Filed: Feb. 9, 2009

(30) Foreign Application Priority Data
Mar. 25, 2008 (EP) 08153237.6

(51) Int. Cl. G06F 9/46; G06F 17/18; G06N 5/02

(52) U.S. Cl. 718/106; 702/181; 706/52

(57) ABSTRACT

Decisions whether or not to initiate certain types of computer operations, such as Just In Time (JIT) compiling or garbage collection can be made using a probabilistic threshold monitor. A decision whether to drive a threshold indicator bit to a set state is made on the detection of each of a certain kind of event occurring over a predetermined interval. The probability that the bit will be driven to a set state upon the detection of any given event is controlled. At the end of the predetermined interval, a computer operation is initiated if the threshold indicator bit is found to be in its set state.

### BACKGROUND

An embodiment of the invention relates to determining whether or not to initiate computer operations based on a probabilistic determination whether detected events meet a predetermined threshold.

Many engineered systems, such as computer systems, make use of thresholds for decision-making within their processing. Threshold values may be used to trigger further processing or simply to record data on specific events. Calculating and storing thresholds conventionally has been done using counters to record the number of event occurrences. The use of counters represents a significant processing and storage cost, in particular when the threshold value is large or there are large number of thresholds being monitored at any given time.

### SUMMARY

One embodiment is a method for controlling initiation of a program operation based on a probabilistic determination whether a set of detected events meets a predetermined threshold. A number of detected events constituting a threshold is determined. The probabillity (a) of said threshold being met for a given detected event is also determined. At the detection of each event, a decision is made whether the threshold has been met. The decision is made in accordance with said probability (a). If the threshold is met, a threshold indicator bit is set to a predetermined binary value. The above operations are repeated for each event detected over a predetermined interval. At the end of the predetermined interval, the program operation is initiated if the threshold indicator bit is set to the predetermined binary value.

Another embodiment is a computer program product for controlling initiation of a program operation based on a probabilistic determination whether a set of detected events meets a predetermined threshold. The computer program product includes a computer usable medium embodying computer usable program code configured to determine a number of detected events that constitute a threshold (X), to determine the probability (a) of the threshold being met for a given detected event, based on the threshold (X), in response to detection of an event, to decide whether or not the threshold (X) should be deemed met, and to set a threshold indicator bit to a predetermined value if the threshold is deemed met. The computer program product further includes computer usable code for causing the above operations to be repeated for each event detected over a predetermined interval and to initiate the program operation if the threshold indicator bit is found to have the predetermined value at the end of the predetermined interval.

Another embodiment is a computer program product for controlling initiation of a program operation based on a probabilistic determination whether a set of detected events meets a predetermined threshold. The computer program product includes a computer usable medium embodying computer usable program code configured to detect the occurrence of each event, upon the occurrence of each event, make a random decision whether a threshold indicator bit should be set to a first binary value, to repeat the above operations for each event detected over a predetermined interval and to initiate the program operation at the end of the predetermined interval if the threshold indicate bit is found to be set to the first value.

Still another embodiment is an apparatus for controlling initiation of a program operation based on a probabilistic determination whether a set of detected events meets a predetermined threshold. The apparatus includes a threshold indicator bit register for storing a bit having a first binary value if a decision has been made that a threshold has been met and a second binary value if no decision has been made that a threshold has been met, an event detector for detecting the occurrence of events occurring during a predetermined interval and a probability generator module for, in response to detection of each event during the predetermined interval, determining whether the threshold has been met and setting the threshold indicator bit to the first binary value in response to a determination that the threshold has been met. Finally, the apparatus includes program control logic operative at the end of said predetermined interval to initiate the program operation if the threshold indicator bit is set to the first binary value.

### BRIEF DESCRIPTION OF THE SEVERAL VIEWS OF THE DRAWINGS

FIG. 1 is a schematic illustration of a computer system in which operations are controlled using a threshold monitor.

FIG. 2 is a schematic illustration of the threshold monitor of FIG. 1.

FIG. 3 is a flow chart illustrating processing performed by the threshold monitor of FIG. 2.

FIG. 4 is a graph illustrating an example of a distribution of events in the threshold monitor of FIG. 2.

FIG. 5 is a graph illustrating receiver operator curves for tuning the threshold monitor of FIG. 2.

FIG. 6 is a schematic illustration of components for making a probabilistic determine whether a threshold bit indicator should be set following a detected event.

FIG. 7 is a flow chart used to describe operations performed by the components shown in FIG. 6.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

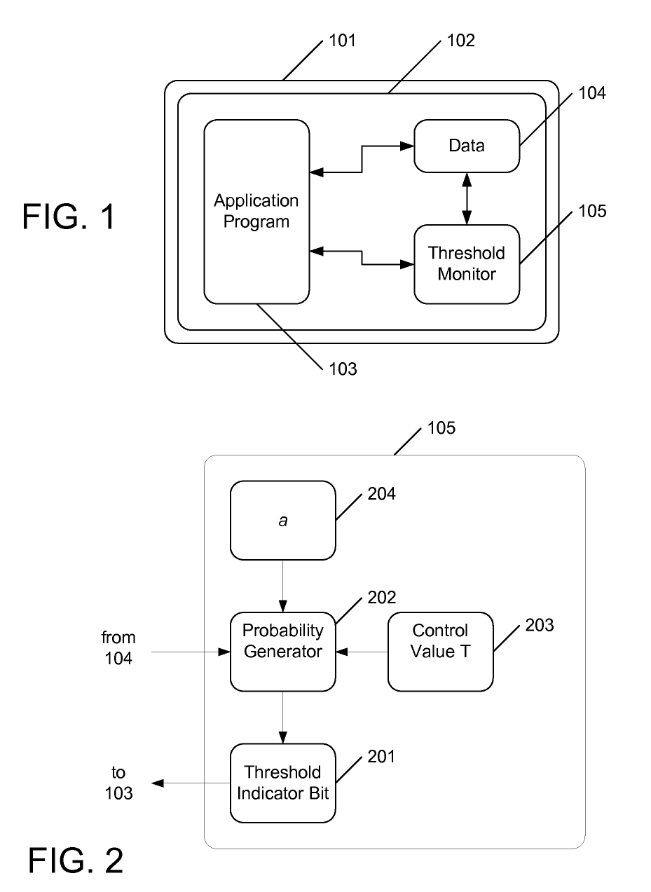

With reference to FIG. 1, an engineered system in the form of a computer system 101 runs an operating system program 102. An application program 103 executes on the operating system 102 and during its execution causes a number of events to occur, the events being associated with a set of data 104. The system 101 further comprises a threshold monitor 105 arranged to probabilistically determine whether the number of events has reached a predetermined threshold. Once the threshold monitor determines probabilistically that the number of such events has met the threshold, the threshold monitor 105 causes the application program 103 to be notified accordingly. The application program may respond to the notification by initiating additional programming operations. Examples of such additional programming operations include invocation of a Just-In-Time (JIT) compiler for object-oriented code that has been run in interpretable mode at a greater than threshold frequency or invocation of garbage collection operations where certain operations have been performed by object-oriented code at greater than a threshold frequency.

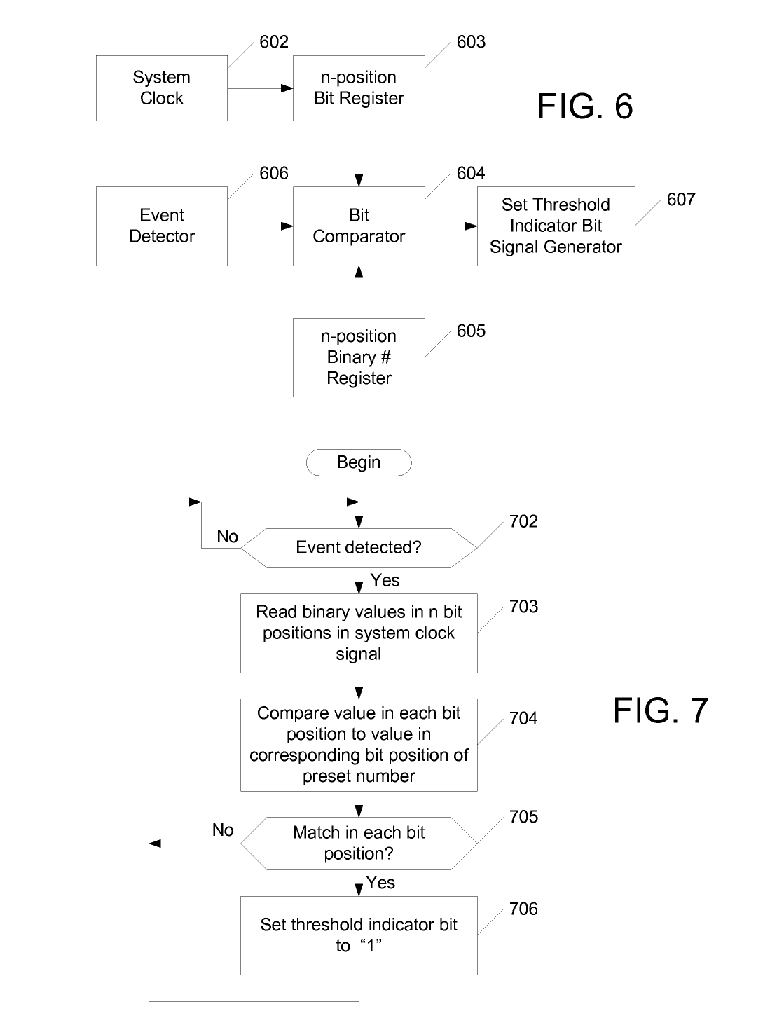

Conventionally, counters would be used to record the number of times an event of interest occurred over a “sampling period”. The threshold monitor 105 does not keep counts of the number of times an event occurs, but instead uses a probabilistic system that operates each time an event is detected to determine whether a threshold indicator bit should be set. One embodiment of such a probabilistic system is described later with reference to FIGS. 6 and 7. Note that the threshold monitor does not actually detect whether the threshold is met as a consequence of the event occurrence but rather whether there is a high enough probability that the threshold will be met as a result of the event, that a threshold indicator bit should be driven to a set state. As a result of the probabilistic nature of the method employed, it is inherent that errors will occur during operation of the threshold monitor 105. The determination of the errors that can be expected is described in further detail below.

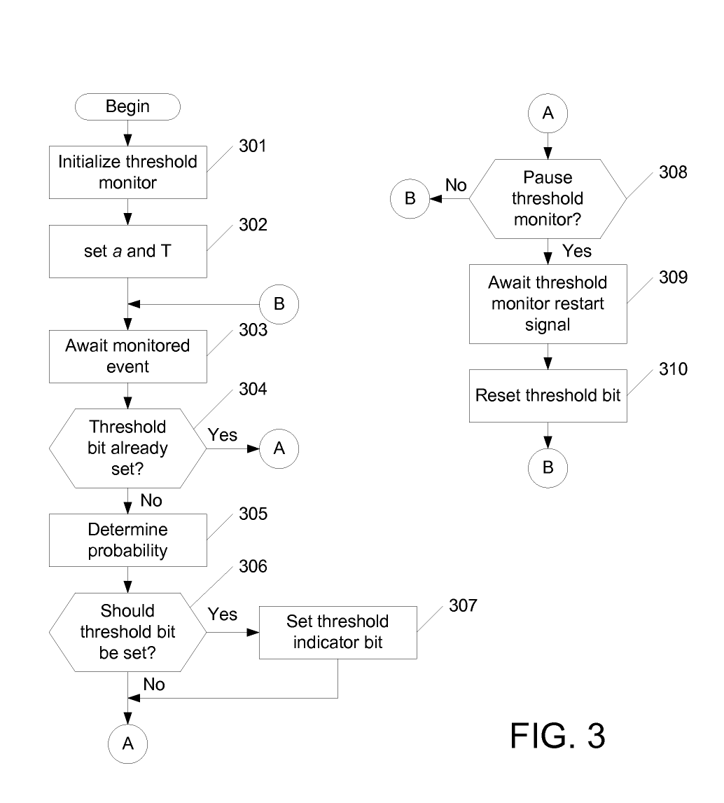

With reference to FIG. 2, the functional elements of the threshold monitor 105 include a threshold indicator bit 201, a probability generator 202, a control value 203 and a single event probability value (a) 204. The threshold indicator bit 201 indicates whether or not a predetermined threshold value (X) has been deemed to have been met in response to detection of events associated with data 104 as a result of operation of the application program 103. The control value 203 is a predetermined value used to control operations involving the threshold monitor 105. In one embodiment, the control value 203 represents a period of time (T) that the threshold monitor 105 will run before it reinitializes. Reinitialization results, among other things, in the threshold indicator bit 201 being driven to 0.

The probability generator 202 detects the occurrence of each event associated with the data 104 and responds by initiating a probability-based calculation that determines whether threshold indicator bit 201 should be driven to a 1 value. The outcome of the probability-based calculation is dependent on the single event probability value (a) 204. In other words, the single event probability value (a) 204 is the probability of driving the threshold indicator bit to 1 as a consequence of the most recently-detected event associated with the data 104. The probability that the threshold indicator bit 201 will be driven to 1 following the detection of an event is based on the number (n) of events that have occurred as defined in the following equation 1:

P(bit=1|n)=1−(1−a)ⁿ (1)

Equation 1 can be inverted to enable the single event probability value (a) 204 to be calculated by the following equation 2:

a=1−(1−P(bit=1|n))^{1/n} (2)

Equation 1 shows that when a is small, the probability P(bit=1|n) varies approximately linearly with the number of events, using the binomial expansion of equation 1 as shown in the following equation 3:

P(bit=1|n)≈nα (3)

In one embodiment, the data 104 includes an object that is accessed over successive time periods as a result of operations by the application program 103. Each access is considered an event. In this embodiment, the threshold monitor 105 probabilistically differentiates those periods in which the object is accessed frequently, referred to herein as hot periods, from those periods in which the object is accessed infrequently, referred to herein as cold periods. The threshold indicator bit 201 is always driven to 0 following each period, regardless whether the period has been characterized as a hot or a cold period. For those periods where the object is accessed infrequently, that is, the number n of detected events is small, the probability of the threshold indicator bit being set to one is low for small a and most of those periods will be identified as cold periods. For those periods where the objects is accessed frequently, that is, the number of detected events n is large, the probability of the threshold indicator bit being set to one is high even for small a and most of those periods will be identified as hot. Suitable selection of a, as described in further detail below, enables statistical discrimination between the cold periods and the hot periods.

In the present embodiment, the threshold value X is the frequency of events within a period T at or above which the period is considered hot. The probabilistic nature of the operation of threshold monitor 105, as indicated by Equation 1, means that some periods will be incorrectly probabilistically determined to be hot or cold when the periods were, in reality, just the opposite. The degree of certainty that a period, for a particular X and T, will be correctly categorized as hot or cold is determined not only by a, but also by the proportion (p(n)) of periods T that have a given n events. This distribution p(n) can be referred to as the empirical distribution of the hotness of the periods. A first example distribution is as follows:

p(n)≡δ_{nX}

where δᵢⱼ is the Kronecker delta, which has a value of one only if n equals X, and otherwise has a value of zero. In the example distribution above, all periods have exactly X events and P(bit=1|X) of the hot periods will be detected.

A second example distribution is as follows:

$$p ( n ) ≡ 0.6 {δ}_{nX} + 0.4 {δ}_{n \frac{X}{10}}$$

In this example, 60% of periods are hot (n=X) and 40% of periods are cold (n=X/10). As noted above, not all periods will be correctly identified as a result of the probabilistic nature of the operation of threshold monitor 105. In the present example, a proportion P(bit=1|X) of the 60% of hot periods will be erroneously identified as cold. In addition, a proportion P(bit=1|X/10) of the 40% of cold periods will also be erroneously identified as hot. The single probability value (a) 204 can be selected, as described in further detail below, to cause P(bit=1|X) to be close to one, but P(bit=1|X/10) to be close to zero.

The accuracy of the threshold monitor 105 as a discriminator depends on the empirical distribution p(n) and on the value of a. For example, if the distribution p(n) is naturally well-separated into hot and cold periods, then the threshold monitor 105 will be better at discriminating between those periods.

In the present embodiment, the distribution p(n) is such that in the hot time periods, the object is accessed exactly 10000 times in 10 million cycles time period (T). Within the cold time periods, the object is accessed less than 10000 times. Assume the threshold monitor 105 is required to have a false negative rate of 1%, that is, a 99% chance of a hot period being correctly identified. Thus the probability of correctly setting the bit to one is given by P(bit=1|n)=0.99, with n=X=10,000. Substituting these values into equation 2 above thus provides a single event probability value (a) 204 of 0.00046. In other words, in order to detect 99% of time periods in which the object is accessed exactly 10000 times, each detected access to the object must cause the threshold indicator bit 201 to be set with a probability 0.00046. The control value in this case is T=10 million cycles, and after such a period, the threshold monitor would be paused and the threshold indicator bit 201 would be frozen with a 99% chance of the threshold indicator bit 201 being set correctly.

In the present embodiment, the probability generator 202 generates a signal to set the threshold indicator bit 201 in accordance with the single event probability value (a) 204. One possible mechanism for implementing this is described immediately below.

Hardware elements which can be used to generate a signal to set the threshold indicator bit 201 include an n-position bit register 603 which can be used to record the binary values of n bit positions in a clock signal provided by a system clock 602. A second register 605 is used to store a randomly selected binary number having n bit positions. Registered 603 and 605 provide inputs to an n-position bit comparator which can compare the binary value stored in a particular bit position in register 603 with the binary value stored in the corresponding bit position in register 605. The operation of the bit comparator 604 is triggered each time an event detector 606 provides a signal indicating an event has been detected. When an event signal has been received, bit comparator 604 compares the contents of the two registers 603 and 605. If a complete match is found for all n positions, a signal is delivered to a signal generator 607 to cause the value of the threshold indicator bit to be driven to a True or “1” value.

In one embodiment, a number of the lowest bits, excluding the lowest three, of a 64 bit processor clock are selected and compared to a randomly chosen predetermined binary number. The lowest three clock bits may be excluded since they usually do not have an equal chance of being either 0 or 1. The selection of the number of clock bits enables the output of the probability generator to be approximated to the required single event probability value (α) 204. For example, the probability that the bottom eleven clock bits will completely match the predetermined binary number is 0.5¹¹=0.0004883, which approximates to the value of the single event probability value (a) 204 (0.00046) in the example above.

FIG. 7 is a flow chart of operations performed using the components already described with reference to FIG. 6. The system begins in a “wait state” 702 in which it is waiting for a signal indicating that an event has been detected. Once that signal is received, the binary values in the pre-selected n bit positions of the system clock are read (operation 703) and compared (operation 704) to the binary values stored in the corresponding bit positions of the predetermined “trigger” number. If a match is found in every position (operation 705), the threshold indicator bit is driven to “1” and the system waits for the next event to be detected.

The operation of the threshold monitor 105 will now be described in further detail with reference to the flow chart of FIG. 3. At step 301, processing in the threshold monitor 105 is initialized when the application program 103 begins to run and processing moves to step 302. At step 302, the values of the single event probability value (a) 204, and the control value (T) 203 are input for the given instance of the threshold monitor 105 and processing moves to step 303. At step 303, the threshold monitor 105 awaits the detection of an event associated with the data 104 and, when such an event is detected, processing moves to step 304. At step 304, the value of the threshold indicator bit 201 is checked to determine whether it is already set. If the bit is not set, processing moves to step 305 where the probability generator module 202 generate a true (“1”) or false (“0”) Boolean value. At step 306, the Boolean value from step 305 is used to determine whether or not the threshold indicator bit 201 should be set to 1 and, if so, processing moves to step 307. At step 307, the threshold indicator bit 201 is set and processing moves to step 308. At step 308, the threshold monitor establishes whether the threshold monitor should be paused in accordance with the control value (T) 203 and if so processing moves to step 309. At step 309, the threshold monitor waits for a signal to restart. When the signal is received, processing moves to step 3 10. At step 310 the threshold indicator bit 201 is reset and processing moves to step 303 to await detection of another event.

If the threshold indicator bit 201 has been set at step 304, then processing moves to step 308 and proceeds as described above. If at step 306, the probability generator module 202 has determined that the threshold indicator bit 201 should not be set then processing moves to step 308. If at step 308, the threshold monitor 105 has determined that the threshold monitor should not be paused then processing moves to step 303 and proceeds as described above.

Using a probability mechanism as described above will result in a certain proportion of false positive or negative indications. In other words, over a set of such threshold mechanisms, some may falsely indicate that the threshold has been met and some may falsely indicate that the threshold has not been met. In the present embodiment, the cold periods consist of the data object 104 being accessed exactly 1000 times, and the predetermined single event probability value (a) 204 is 0.00046. For those cold periods, the probability P(bit=1|n) of the threshold indicator bit being set to 1 in 10 million cycles is P(bit=1|n=1000)=37%. Thus 37% of the cold periods are misclassified as hot.

It will generally be preferable for P(bit=1|n) to be as close to one when the number of accesses (n) exceeds the threshold (X) but also for P(bit=1|n) to be close to zero when the number of accesses is less than the threshold (X) to minimize false positive and false negative indications. The single event probability (α) 204 controls the false positive and false negative indications. Thus, in the present embodiment, the single event probability value (a) 204 can be chosen to be smaller. This will have the cost of decreasing the proportion P(bit=1|n=10000) of hot periods that are detected, with the benefit of decreasing the proportion P(bit=1|n =1000) of cold periods that are misclassified. The false positives can be reduced at the expense of some false negatives.

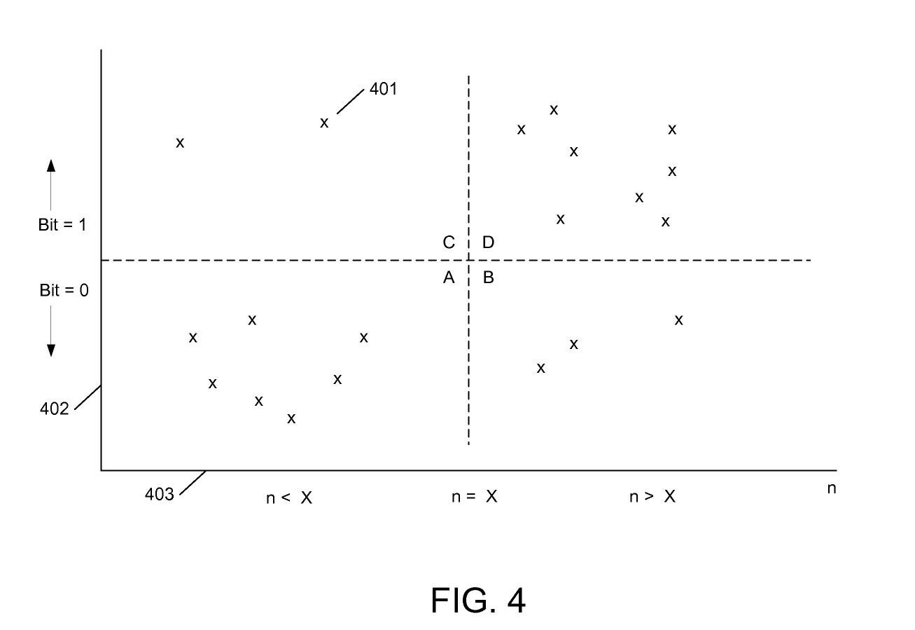

The derivation of the false positive and false negative rates will now be described in further detail below. This enables the accuracy of the method to be determined in terms of the hotness distribution p(n), the value chosen for the single event probability value (a), and the control value (T). The graph of FIG. 4 illustrates the distribution of periods in terms of their actual hotness (n) and the hotness as indicated by the threshold indicator bit 201 in the threshold monitor 105. For instance an indication of hotness 401 shows a period which has a bit set to one, but whose actual hotness is lower than the threshold X, and thus represents a false positive. The indications are distributed over a first, second, third and fourth quadrants A, B, C, D along an y-axis 402 depending on whether the bit is set and along the x-axis 403 depending on whether the number of events exceeds the threshold. The first and fourth quadrants A, D refer to correctly identified indications while the second and third quadrants B, C are incorrectly identified indications and correspond to the false negatives and false positives respectively. The number of errors is illustrated by the number of indications in the second and third quadrants B, C.

The standard terminology for false positive and false negative rates is used, which are also referred to as Type I and Type II errors respectively. The false positive rate is the proportion of negative incidences that were erroneously reported as being positive, that is, the indications 401 in the third quadrant as a proportion of the total incidences in quadrants A and C, 2/(7+2)=22%. Similarly the false negative rate is the proportion of positive incidences that were erroneously reported as being negative. The false positives and false negatives can also be expressed as absolute rates. The absolute false negative rate is defined as the proportion of all incidences that were erroneously reported as being negative. Similarly, the absolute false positive rate is defined as the proportion of all incidences that were erroneously reported as being positive.

The absolute rates for the quadrants can written as joint probabilities which is the joint probability of the bit being a given value and the number of events being within a given range as follows:

P({bit=0,bit=1},{n<X,n≧X})

And the absolute false negative rate, that is for quadrant B, is defined as:

P(bit=0,n≧X)

Thus, the absolute false positive rate, that is for quadrant C, is defined as:

P(bit=1,n<X)

From Bayes' theorem the joint probability P(bit=1, n) of bit being set to one and the number of events being exactly n is given by:

P(bit=1,n)=P(bit=1|n).p(n)

Thus, the formula for calculating the absolute proportion of false negative and false positive indications in the second and third quadrants B, C respectively are as follows:

P(bit=0,n≧X)=Σ_{n≧X}p(n).P(bit=0|n)

P(bit=1,n<X)=Σ_{n<X}p(n).P(bit=1|n)

P(bit=0|n) or P(bit=1|n) are known from equation 1 above and thus only the probability distribution p(n) is required in order to estimate the absolute false positive and false negative rates. The probability distribution p(n) depends on the particular system to which the threshold mechanism described herein is applied and may be determined theoretically or empirically.

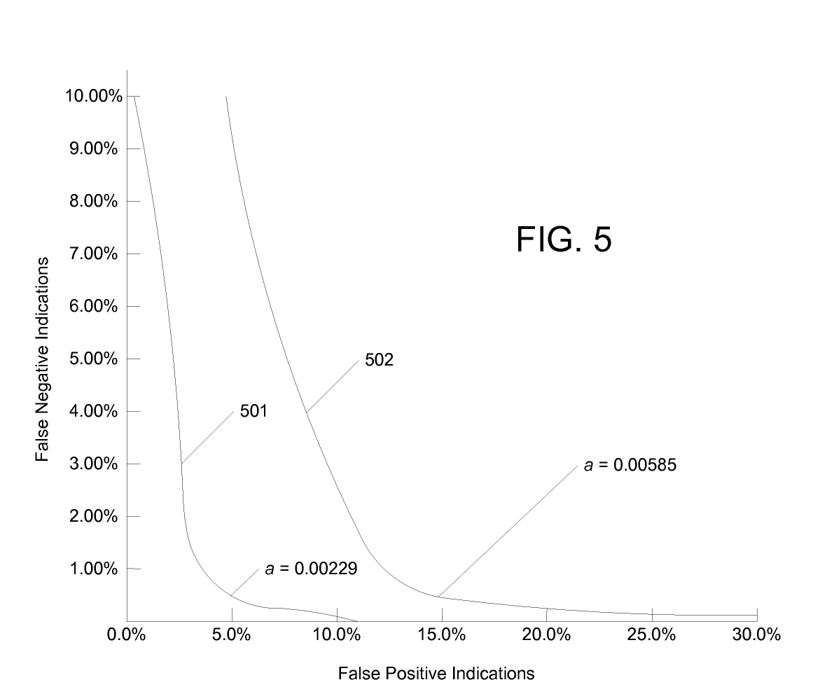

With reference to FIG. 5, when the probability distribution p(n) has been established over a given control value 203 (T), a set of receiver-operator curves 501, 502 can be calculated. The first receiver-operator curve 501 provides the absolute error rates, that is, the error rate as a proportion of the total number of indications. The second receiver-operator curve 502 provides the standard error rates, that is, relative to the positive incidences for false negatives, or relative to negative incidences for false positives. In the example of FIG. 5, the threshold X was set at 200 and with the specific empirical p(n), the percentage of actual hot indications (Q) was 10%. The receiver-operator curves 501, 502 enable the value of α to be selected, so as to balance acceptable standard or absolute error rates against an applicable probabilistic threshold X and control value T. Thus in the example of FIG. 5, balancing the standard and absolute error rates at 5.2% and 2.1% respectively result in respective values of the single event probability value (α) of 0.00585 and 0.00229 against a given threshold X and control value T.

The probabilistic threshold system described herein provides a low cost mechanism applicable in situations where the threshold triggering determinations can tolerate some errors, such as false positives or false negatives. One example of such a situation is making a determination when interpreted code is being called with such frequency that it becomes desirable to subject the code to a Just In Time (JIT) compiling operation. Another example of such a situation is making decisions how to perform garbage collection operations for objects that have been involved in past operations.

In another embodiment, a set of events act on a set of items, with the same threshold being provided for each such item, but there is a single time period of length T. Thus, the data consists of fields of objects and the events are accesses to these fields. Each field is monitored separately and each field has an associated threshold bit in the threshold monitor. Thus the hot fields are accessed X or more times in the time period T and the cold fields are accessed less than X times in the same control period (T). Given a requirement of the threshold monitor have a given false negative rate of detecting the hot fields, then using the same methods as above, the single event probability value (a) 204 is chosen to provide such a rate. In the present embodiment, the control period may be defined in terms of the number of detected events rather than a time period. The present embodiment may be viewed as an alternative version of the embodiment described in detail above.

As described above, Q is the percentage of fields that have X or more accesses, that is, the percentage of hot fields. Thus in some embodiments, the threshold may be the number of events X and in other embodiments, the percentage of hot fields Q may be used. In other words, either Q or X is the quantity that is pre-selected. Q depends empirically on the threshold X, the empirical distribution p(n) and control value T. X depends empirically on Q, p(n) and T. The use of either Q or X as a threshold is dependent on the particular implementation of the mechanism.

In a further embodiment, no specific threshold (X) is defined and the system is arranged to provide a relative measure of the frequency of the monitored event from one period (T) to another. In other words, each time an event is detected, a random decision is made as to whether or not the event is frequently occurring, with the chance of a positive decision at each event being the single event probability (a). In another embodiment, no specific threshold (X) or single event probability (a) is defined so as to provide a completely random indication of the frequency of the monitored event. So long as the actual probability of a single event triggering a positive decision is relatively low, this mechanism will provide a means for distinguishing between more active and less active time periods.

As will be understood by those in the art, while in the above embodiments, the events are exemplified as accesses of data, the described mechanisms may be applied to any other such measurable event. For example, the mechanism may be used for monitoring the statistics of a data locking device.

As will be understood by those skilled in the art, any suitable alternative mechanism may be arranged for providing the functions of the probability generator as described above. The same mechanism or differing mechanisms may be employed for setting the threshold indicating bit with a probability of a and for pausing and later resetting the threshold indicating bit according to the control value (T). In other words, the control value (T) may be determined empirically instead of being a predetermined time period. As will be understood by those skilled in the art, any other suitable form of providing a control value may be employed in embodiments of the invention

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for controlling initiation of a program operation based on a probabilistic determination whether a set of detected events meets a predetermined threshold, said method comprising:
a) determining a number of detected events that constitute a threshold (X);
b) determining the probability (a) of said threshold being met for a given detected event, based on said threshold (X);
c) in response to the detection of an event, deciding whether or not said threshold (X) has been met, said decision being a determination that said threshold has been met in response to said event in accordance with said probability (a);
d) in response to a decision that said threshold (X) has been met, setting a threshold indicator bit to a predetermined binary value;
e) repeating operations c) and d) for events occurring over a predetermined interval; and
f) at the end of said predetermined interval, initiating the program operation if the threshold indicator bit is set to the predetermined binary value.

2. A method according to claim 1 in which said probability (a) is based on said threshold (X) and on an overall probability of at least one said positive decision being made after detection of the number of events that constitute said threshold (X).

3. A method according to claim 1 wherein deciding whether or not said threshold (X) has been met further comprises generating a signal indicating whether or not said threshold indication bit should be set, said signal being generated in accordance with said single event probability (a).

4. A method according to claim 1 in which said predetermined interval is a predetermined time period (T).

5. A method according to claim 1 in which said predetermined interval is a predetermined number of events.

6. A method according to claim 1 wherein deciding whether or not said threshold (X) has been met further comprises:
(g) upon detection of an event, reading the binary value in each of a set of predetermined bit positions in a system clock signal;
(h) comparing the read binary values to binary values in corresponding bit positions in a predetermined binary number; and
(i) deciding said threshold (X) has been met only if the compared binary values coincide in every bit position.

7. A computer program product for controlling initiation of a program operation based on a probabilistic determination whether a set of detected events meets a predetermined threshold, said computer program product comprising a computer usable medium having computer usable program code embodied therewith, said computer usable program code comprising:
a) computer usable program code configured to determine a number of detected events that constitute a threshold (X);
b) computer usable program code configured to determine the probability (a) of said threshold being met for a given detected event, based on said threshold (X);
c) computer usable program code configured to, in response to the detection of an event, decide whether or not said threshold (X) has been met, said decision being a determination that said threshold has been met in response to said event in accordance with said probability (a);
d) computer usable program code configured to, in response to a decision that said threshold (X) has been met, set a threshold indicator bit to a predetermined binary value;
e) computer usable program code configured to repeat operations c) and d) for all events occurring over a predetermined interval; and
f) computer usable program code configured to, at the end of said predetermined interval, initiate the program operation if the threshold indicator bit is set to the predetermined binary value.

8. A computer program product according to claim 7 in which said probability (a) is based on said threshold (X) and on an overall probability of at least one said positive decision being made after detection of the number of events that constitute said threshold (X).

9. A computer program product according to claim 7 wherein said computer usable program code configured to, in response to the detection of an event, decide whether or not said threshold (X) has been met further comprises computer usable program code configured to generate a signal indicating whether or not said threshold indication bit should be set, said signal being generated in accordance with said single event probability (a).

10. A computer program product according to claim 7 in which said predetermined interval is a predetermined time period (T).

11. A computer program product according to claim 7 in which said predetermined interval is a predetermined number of events.

12. A computer program product according to claim 7 wherein said computer usable program code configured to decide whether or not said threshold (X) has been met further comprises:
(g) computer usable program code configured to, upon detection of an event, read the binary values in each of a set of predetermined bit positions in a system clock;
(h) computer usable program code configured to compare the read binary values to binary values in corresponding bit positions in a predetermined binary number; and
(i) computer usable program code configured to decide said threshold (X) has been met only if the compared binary values coincide in every bit position.

13. An apparatus for controlling initiation of a program operation based on a probabilistic determination whether a set of detected events meets a predetermined threshold, said apparatus comprising:
a) a threshold indicator bit register for storing a bit having a first binary value if a decision has been made that a threshold has been met and a second binary value if no decision has been made that a threshold has been met;
b) an event detector for detecting the occurrence of events occurring during a predetermined interval;
c) a probability generator module for, in response to detection of each event during the predetermined interval, determining whether the threshold has been met and setting the threshold indicator bit to the first binary value in response to a determination that the threshold has been met; and
f) program control logic operative at the end of said predetermined interval to initiate the program operation if the threshold indicator bit is set to the first binary value.

14. An apparatus according to claim 13 further comprising a signal generator for generating a signal indicating whether or not said threshold indication bit should be set, said signal being generated in accordance with said single event probability (a).

15. An apparatus according to claim 13 in which said predetermined interval is a predetermined time period (T).

16. An apparatus according to claim 13 in which said predetermined interval is a predetermined number of events.

17. An apparatus according to claim 13 wherein said probability generator module further comprises:
(g) a reader module for, upon detection of an event, reading the binary values in each of a set of predetermined bit positions in a system clock;
(h) a comparator for comparing the read binary values to binary values in a predetermined binary number; and
(i) decision logic for deciding said threshold (X) has been met only if the compared binary values coincide in every bit position.

18. A computer program product for controlling initiation of a program operation based on a probabilistic determination whether a set of detected events meets a predetermined threshold, said computer program product comprising a computer usable medium having computer usable program code embodied therewith, said computer usable program code comprising:
a) computer usable program code configured to detect the occurrence of each event;
b) computer usable program code configured to, upon the occurrence of each event, make a random decision whether a threshold indicator bit should be set to a first binary value;
c) computer usable program code configured to cause operations a) and b) to be repeated over a predetermined interval; and
d) computer usable program code configured to, at the end of said predetermined interval, initiate the program operation if the threshold indicator bit is set to the first binary value.

19. A computer program product according to claim 18 in which said predetermined interval is a predetermined time interval.

20. A computer program product according to claim 18 in which said predetermined interval is a predetermined number of events.
